(19) United States
(12) Patent Application Publication
(10) Pub. No.: US 2025/0202113 A1
(43) Pub. Date: Jun. 19, 2025

(54) SIGNAL COUPLER CONFIGURATIONS

(71) Applicant: Galtronics USA, INC., Tempe, AZ (US)

(72) Inventors: Alireza GHARAATI JAHROMI, Ottawa (Kanata) (CA); Azita GOUDARZI, Ottawa (Kanata) (CA); Zhihua YU, Kanata (CA); Sadegh FARZANEH, Ottawa (Kanata) (CA); Mohammadmahdi FARHANI, Ottawa (Kanata) (CA)

(73) Assignee: Galtronics USA, INC., Tempe, AZ (US)

(21) Appl. No.: 19/064,286

(22) Filed: Feb. 26, 2025

Related U.S. Application Data
(63) Continuation-in-part of application No. 17/769,625, filed on Apr. 15, 2022, now Pat. No. 12,266,867.
(60) Provisional application No. 62/923,352, filed on Oct. 18, 2019.

(51) Int. Cl. H01Q 5/28; H01Q 21/00; H04B 7/0408

(52) U.S. Cl. CPC H01Q 5/28; H01Q 21/0006; H04B 7/0408

(57) ABSTRACT

Systems and methods relating to couplers for coupling signals, with the couplers being suitable for use in multibeam forming networks (MBFNs). A multilayer configuration is disclosed with a top layer, a bottom layer, and a middle layer. The middle layer may be configured with windows or cutouts to allow for coupling between signals traveling in circuit traces on the top and bottom layers. Different window configurations and different circuit trace configurations are disclosed to improve coupling and/or MBFN performance. Also disclosed is an SSL-based coupler that may also be used in MBFNs.

### CROSS-REFERENCE TO RELATED APPLICATIONS

The present Application is a Continuation-in-Part of U.S. Patent Application No. 17/769,625 titled “MITIGATING BEAM SQUINT IN MULTI-BEAM FORMING NETWORKS” and filed on Apr. 15, 2022, which is a National Phase Entry under 35 U.S.C. § 371 of PCT App. No. PCT/US2020/035186 titled “MITIGATING BEAM SQUINT IN MULTI-BEAM FORMING NETWORKS” and filed May 29, 2020, which claims priority to U.S. Provisional Patent Application No. 62/923,352 titled “MITIGATING BEAM SQUINT IN MULTI-BEAM FORMING NETWORKS” and filed on Oct. 18, 2019, the entire disclosures of which are incorporated herein by reference.

### TECHNICAL FIELD

The present invention relates to circuitry and manufacturing methods for use with antennas and antenna systems. More specifically, the present invention relates to couplers and coupler-related techniques for improving coupler performance in multibeam beamforming networks.

### BACKGROUND

To increase the communication capacity of base stations, multi-beam base station antenna arrays are required to divide the coverage of the base station from an entire area into several smaller cells. As well, it is expected to keep each beam's coverage to be the same within the whole operating frequency band.

Multi-beam antennas may be formed from ordinary antenna arrays that are fed by multi-beam forming networks (MBFNs). One type of MBFNs is usually based on directional couplers, phase shifters, and crossovers. The features of the components only depend on the electrical lengths of the transmission lines to build the components. Since the components can be implemented using planar circuits and since the sizes of the components can be reduced by using meander lines or high-dielectric laminates, the volume of the networks is generally much smaller than the lens based multibeam antennas. Such antenna systems may use Butler matrices, Blass matrices, Nolen matrices, as well as other types of matrices.

As an example of a matrix based MBFN, a Blass matrix is a microwave feeding network for antenna arrays and it uses directional couplers to connect rows and columns of transmission lines that form the matrix, For such an MBEN, the rows of the matrix may correspond to the number of beams to be generated while the columns are connected to the radiating elements. The directional couplers connect the rows and the columns at each crossover point. At each crossover, a small portion of the signal is coupled into each column, thereby exciting the corresponding radiating element.

In some uses, to have a better efficiency for the system and to thereby result in lower loss and higher quality pattern results, it is desirable to have couplers with a high coupling value (i.e., greater than 3 dB). However, such high coupling values tend to degrade the return loss and isolation performance of the coupler. As should be known to those of skill in the art, as coupling values increase past 3 dB, coupler performance, at least in terms of return loss and isolation, degrades.

There is therefore a need for couplers and coupler related techniques and technologies that can increase or at least maintain coupler performance while maintaining high coupling values.

### SUMMARY

The present invention provides systems and methods relating to couplers for coupling signals, with the couplers being suitable for use in multibeam forming networks (MBFNs). A multilayer configuration is disclosed with a top layer, a bottom layer, and a middle layer. The middle layer may be configured with windows to allow for coupling between signals traveling in circuit traces on the top and bottom layers. Different window configurations and different circuit trace configurations are disclosed to improve coupling and/or MBFN performance. Also disclosed is an SSL-based coupler that may also be used in MBFNs.

In a first aspect, the present invention provides a multi beam forming network of circuit elements manufactured using a multi-layer structure, said multi-layer construction comprising:
a top layer having a top circuit trace, said top circuit trace being a continuous top trace having at least one top island trace;
a middle ground layer having at least one window;
a bottom layer having a bottom circuit trace, said bottom circuit trace being a continuous bottom trace having at least one bottom island trace;
   wherein
   at least one of said at least one window aligns with both of said at least one top island trace and said at least one bottom island trace such that coupling occurs between signals passing through said at least one top island trace and said at least one bottom island trace;
   said at least one window is configured with a plurality of corners and said at least one window having a length and a height.

In a second aspect, the present invention provides a signal coupler that comprises a substrate having a first side and a second side that is opposite said first side, the coupler comprising:
a first layer atop said substrate, the first layer comprising a first conductive trace with a first port at one end of said first conductive trace and a second port at another end of said first conductive trace, said first port being located adjacent said first side and said second port being located adjacent said second side;
a second layer underneath said substrate, the second layer comprising a second conductive trace with a third port at one end of said second conductive trace and a fourth port at another end of said second conductive trace, said third port being located adjacent said second side and said fourth port being located adjacent said first side;
a metallic housing enclosing said coupler;
   wherein said first layer and said second layer are both separated from said metallic housing by an air gap.

In another aspect, the at least one window has rounded corners. As well, at least one of said at least one top island trace is symmetrical about a center longitudinal axis of said continuous trace. Additionally, at least one of said at least one bottom island trace is symmetrical about a center longitudinal axis of said continuous bottom trace,

Furthermore, at least one of said at least one top island trace is asymmetrical about a center longitudinal axis of said continuous trace. As well, at least one of said at least one bottom island trace is asymmetrical about a center longitudinal axis of said continuous bottom trace.

Additionally, the middle ground layer has a plurality of windows. As a variant, at least one of said plurality of windows is differently configured from others of said. plurality of windows. Furthermore, at least one of said plurality of windows is differently shaped from others of said plurality of windows.

As another aspect, at least one of said plurality of windows is differently sized from others of said plurality of windows. At least one window of said plurality of windows may have a height that is greater in value than its length. Alternatively, at least one window of said plurality of windows has a length that is greater in value than its height.

In another configuration, there is an air gap between said top layer and said middle layer. Additionally, there may be an air gap between said bottom layer and said middle layer.

Yet another aspect of the present invention provides that the middle layer comprises multiple layers. Furthermore, the middle layer may comprise at least two copper layers that operate as ground layers for said top layer and said bottom layer.

For the coupler, the substrate may be a metallized dielectric. As well, the coupler may comprise conductive fingers that extend from said conductive traces towards a nearest side of said first and second sides. Additionally, an area of said substrate covered by said first conductive trace atop said substrate does not overlap an area of said substrate covered by said second conductive trace underneath said substrate.

### BRIEF DESCRIPTION OF THE DRAWINGS

The embodiments of the present invention will now be described by reference to the following figures, in which identical reference numerals in different figures indicate identical elements and in which;

FIG. 1 and FIG. 2 illustrate Blass matrices which may be used in MBFNs;

FIG. 3 and FIG. 4 illustrate Nolen matrices which may be used in MBFNs;

FIGS. 5A-5F illustrate a multilayer configuration for implementing an MBEN matrix;

FIGS. 6, 7, 10, and 11 illustrate various configurations that feature a ground cut-out and circuit traces for use in the multilayer configuration according to various aspects of the present invention;

FIG. 8 illustrates the S parameter performance for a conventional ground cut-out and circuit traces as used in the multilayer configuration as shown in FIGS. 5A-5F;

FIG. 9 illustrates the S parameter results for the ground cut-out and circuit traces according to aspects of the present invention as used in the multilayer configuration as shown in FIGS. 5A-5F;

FIG. 12 illustrates S parameter results for the configuration in FIG. 10 using 2 dB couplers and C-band frequencies;

FIG. 13 illustrates S parameters results for the configuration shown in FIG. 11;

FIGS. 14A and FIG. 14B illustrate variants of the various island traces and the various ground cutouts or windows that may be used with the multilayer configuration of the present invention;

FIGS. 15A and 15B illustrate further variants of the various island traces and the various cutouts or windows that may be used with the multilayer configuration of the present invention;

FIG. 16 shows a side cutout of an implementation of one aspect of the present invention;

FIG. 17 shows a microstrip implementation that using the stacked layers shown in FIG. 16;

FIG. 18 is a perspective view of one section of the multilayer implementation of one aspect of the present invention;

FIG. 19 is another implementation of the present invention that uses air gaps;

FIG. 20 is a schematic view of a structure which may be used to implement an SSL based coupler;

FIG. 21 shows a plot of insertion loss for both SSL technology and microstrip technology;

FIG. 22 shows one configuration for one aspect of the present invention using SSL technology;

FIGS. 23A and 23B show S parameter results for a conventional SSL coupler;

FIGS. 24A and 24B show S parameter results for an SSL coupler according to one aspect of the present invention;

FIG. 25 shows another configuration for an SSL based coupler according to one aspect of the present invention;

FIG. 26 shows the various ports and their functions for a 4 port directional coupler;

FIG. 27 shows a Blass matrix implementation used to test the configuration shown in FIG. 25; and

FIG. 28 shows radiation patterns for the antenna and the MBFN using the Blass matrix implementation in FIG. 27 with the SSL based coupler in FIG. 25.

### DETAILED DESCRIPTION

As noted above, Blass, Nolen, and other matrix based MBFN may use couplers to couple rows with columns in their matrices. Examples of such matrix based MBFNs are provided below.

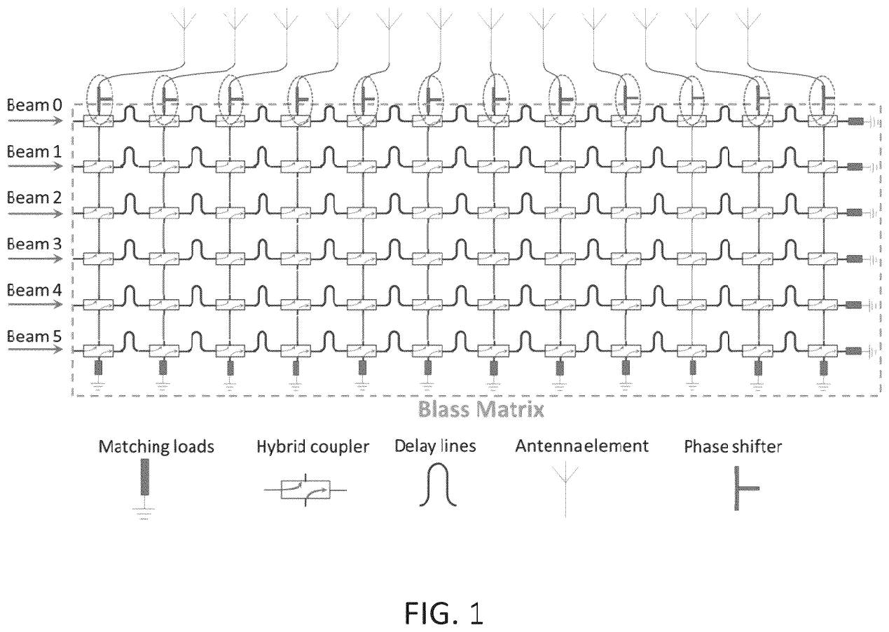

FIG. 1 shows a conventional Blass matrix with couplers in each row being coupled in series by way of delay lines. Column-wise, each coupler in the bottom row is coupled between a matching load and a coupler in a succeeding row. Also, each coupler in the top row is coupled between a coupler in a preceding row and a phase shifter. Each phase shifter is coupled between a coupler in the top row and an antenna array element. As can be seen from the Figure, each coupler couples a column to a row and thereby couples an incoming beam (i.e. Beam 0 to Beam 5) to the various antenna elements.

The schematic diagram in FIG. 1 is an example of an MBFN for a 12-element 6-beam application. It can be seen from FIG. 1 that each row of the Blass matrix circuit has a plurality of directional couplers coupled in series row-wise. Each row-wise pair of directional couplers is joined by at least one delay line. The top row of directional couplers is coupled to antenna elements of the antenna array. This is done such that each directional coupler of the top row is coupled to an antenna element by way of a phase shifter. In this implementation, the bottom row of the matrix circuit is coupled to matching loads such that each directional coupler in the bottom row is coupled column-wise between a matching load and a directional coupler from a succeeding row.

It should be noted that, for a regular Blass matrix, the antenna elements need not be coupled to the matrix by way of a phase shifter.

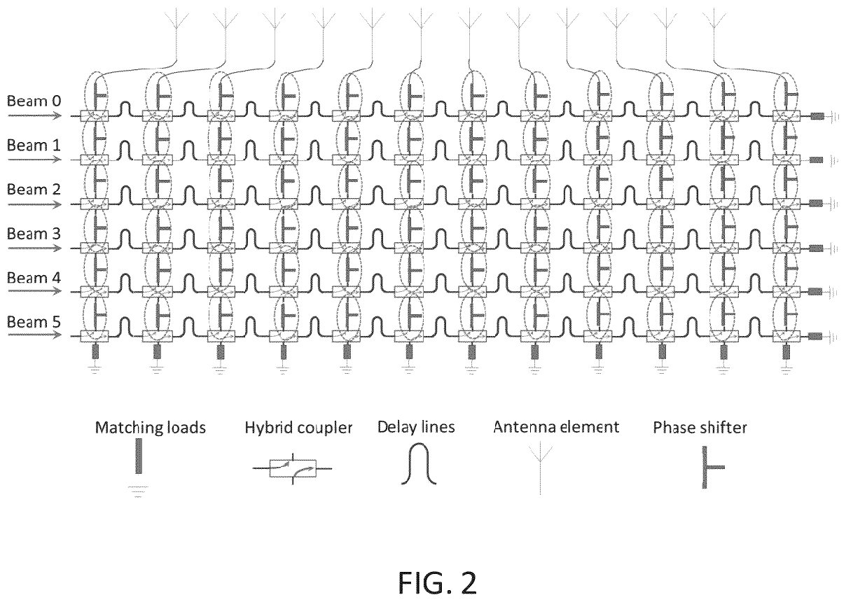

Another implementation of a Blass matrix with couplers is illustrated in FIG. 2. As can be seen in FIG. 2, each row of directional couplers in the matrix circuit is sandwiched between rows of phase shifters. The bottom row of directional couplers is sandwiched between a row of matching loads and a row of phase shifters. Each directional coupler in the bottom row is therefore coupled between a phase shifter and a matching load. With the exception of these bottom row directional couplers, each directional coupler is coupled between two phase shifters. For the top row of phase shifters, each phase shifter is coupled between a directional coupler from the top row of directional couplers and an antenna array element,

In this variant of a Blass matrix, there are two groups of phase shifters—the first group is between the top row of directional couplers and the antenna elements while the second group is placed between adjacent rows of directional couplers in the matrix circuit. In the top row of directional couplers, each directional coupler is coupled column-wise between a phase shifter of the second group of phase shifters and a phase shifter of the first group of phase shifters. In the bottom row of this variant, the bottom row is coupled to matching loads such that each directional coupler in the bottom row is coupled column-wise between a matching load and a phase shifter.

The configuration of the phase shifters in this variant has each phase shifter of the second group of phase shifters being coupled between directional couplers of adjacent rows in the matrix circuit. This is configured such that each directional coupler is coupled in series column-wise to at least one phase shifter of said the second group of phase shifters. It should be clear that while such an implementation currently uses phase shifters with fixed parameters, programmable phase shifters (or phase shifters with changing parameters) are also possible.

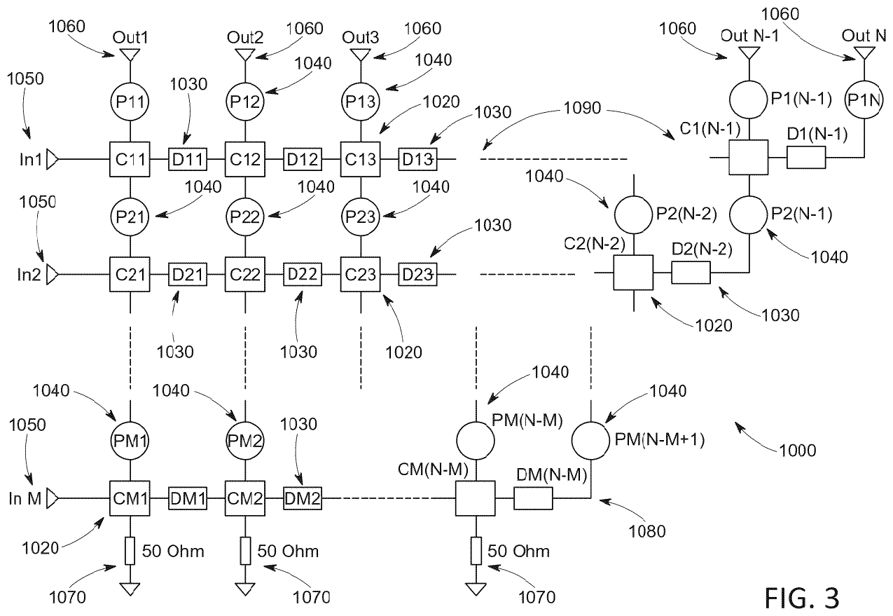

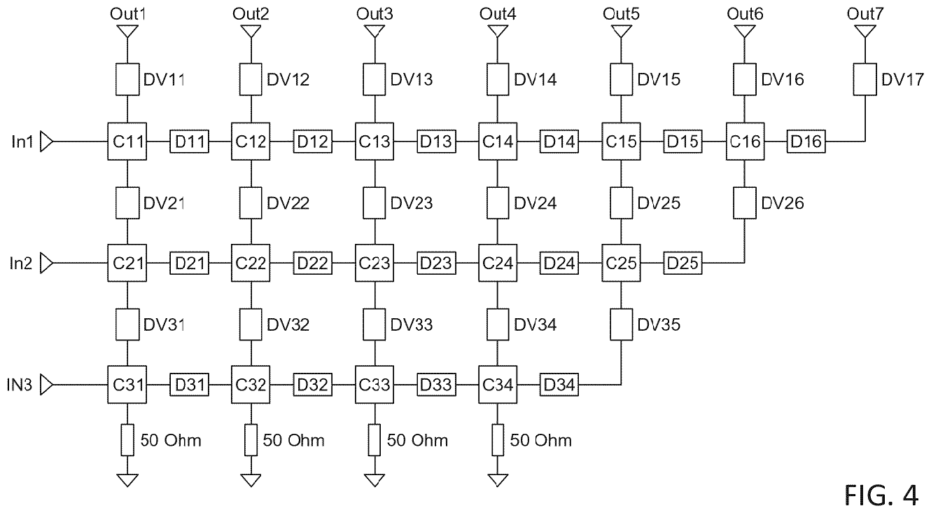

Referring to FIG. 3 and FIG. 4, illustrated are two variants of a Nolen matrix.

Referring to FIG. 3, a schematic diagram of a conventional Nolen matrix is illustrated. As is known, a conventional Nolen matrix consists of different components such as directional couplers, phase delay lines and so on. The Nolen matrix in FIG. 3 has M inputs (input signal beams) and N outputs (antenna outputs/antenna elements).

As can be seen in FIG. 3, the Nolen matrix 1000 has a number of columns and rows with couplers 1020, horizontal phase delay lines 1030, and vertical circuit element lines 1040. The Nolen matrix couples the input signal beams 1050 to the output antenna elements 1060 through the various couplers, phase delay lines, and circuit element lines. It should be clear that each column of the Nolen matrix has a collection of couplers and circuit element lines between an output antenna element and a load 1070. It should also be clear that the lowest row of the Nolen matrix is the row 1080 that is most adjacent the loads 1070 (and most adjacent to ground) while the highest row of the Nolen matrix is the row 1090 that is most adjacent to the output antenna elements 1060.

For greater clarity, in FIG. 3, the couplers are shown in squares denoted with a “C”, the horizontal phase delay lines are shown in rectangles denoted with a “D”, and the vertical circuit element lines are shown in circles denoted with a “P”. The coupling factors and phase delay lines are calculated using software. It should be noted that, in a conventional Nolen matrix, there are some phase errors which degrades the performance of the matrix.

In one variant of a Nolen matrix, only transmission lines are used between the output of each row to the input of the next row. A sample 3-beam input, 7-element output structure was designed using this variant and this is illustrated in FIG. 4.

In FIG. 4, the vertical phase delay lines (shown in rectangles with “DVnm”) may be optimized to compensate for issues that the matrix/antenna system may have such as phase error, beam squint and SLL (side lobe level) related issues. As can be imagined, the couplers in FIG. 3 and FIG. 4 are labeled as “Com” and are seen as intersections between rows and columns in the matrix.

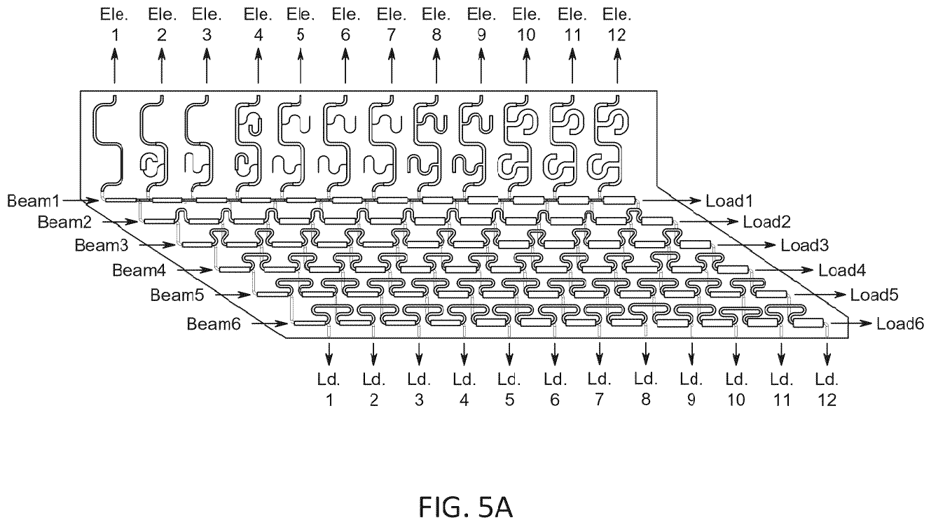

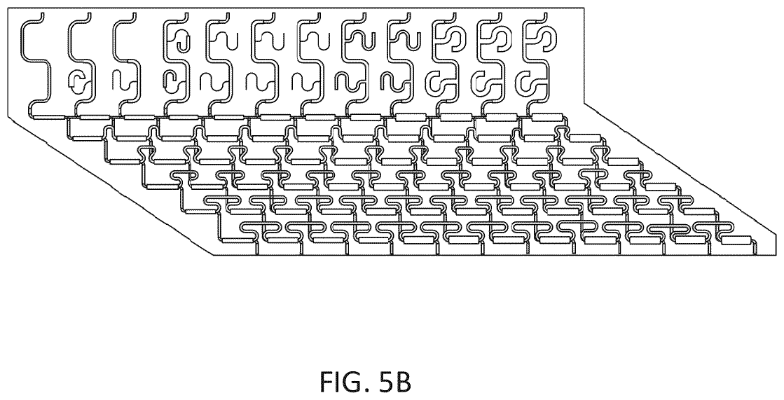

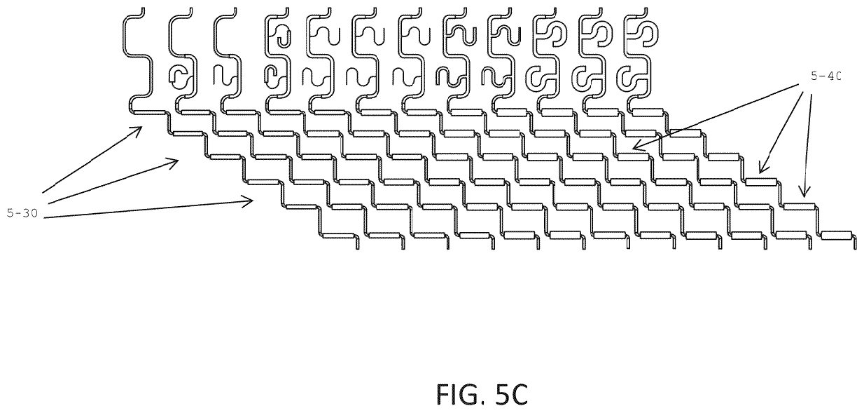

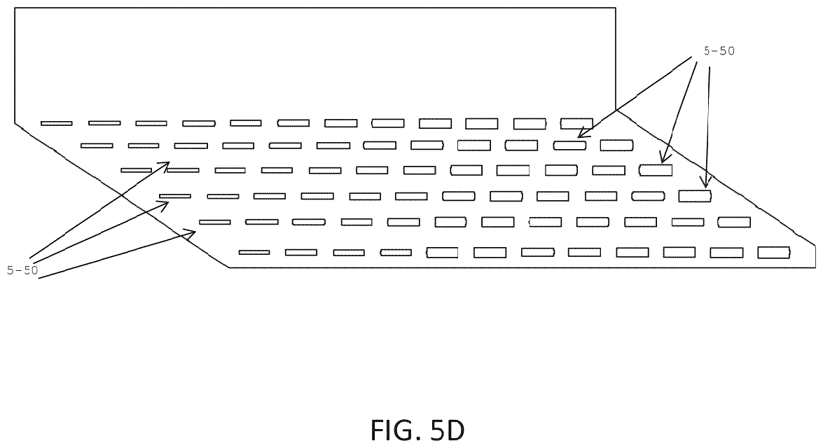

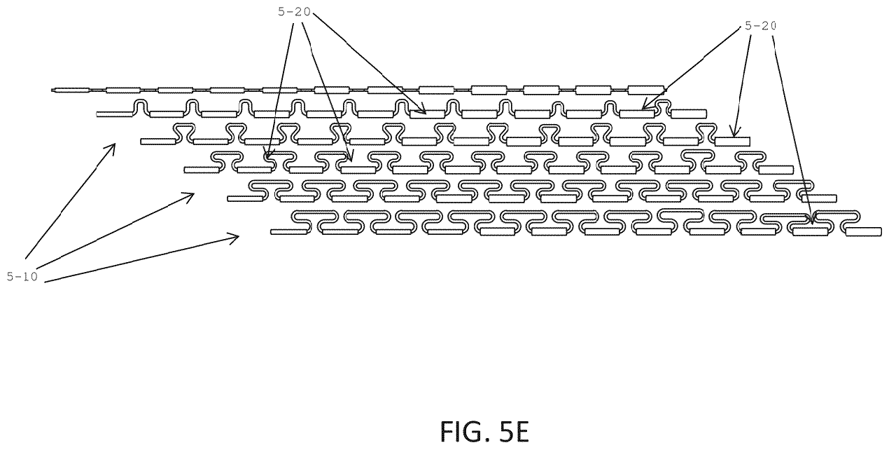

In terms of implementation, the various types of matrix circuits discussed above may be implemented using a multilayer board configuration. Referring to FIGS. 5A-5F, illustrated is a configuration according to such a multilayer configuration. For the configuration illustrated in the figures, illustrated is a 12-element 6-beam MBEN without beam squint. The overall configuration, positions of ports and loads, layouts of each layer, and the cross-section view of the example is shown in FIGS. 5A-5F. FIG. 5A shows the overall configuration of the system detailing the definitions of the beam ports, element ports, and loads. As can be seen from FIG. 5A, implemented is a Blass matrix using a 3 layer configuration, with a top layer, a middle layer, and a bottom layer. In between the top, middle, and bottom layers are substrate layers. FIG. 5B is a top view of the copper layers for the system in one diagram. FIG. 5C is the bottom layer layout, FIG. 5D is the middle (ground layer) layer layout (a “mask” with cutout regions or holes or windows to allow the traces on the top and bottom layers to couple to one another), and FIG. 5E is the top layer layout. FIG. 5F is a cross-sectional view of the resulting circuit board for this implementation, detailing the top, middle, and bottom layers as well as the substrate layers.

As can be seen from FIG. 5E, the top layer has top circuit traces 5-10, with the circuit traces being continuous and each trace having multiple island traces 5-20. From FIG. 5C it can be seen that the bottom layer also has circuit traces 5-30. These circuit traces also have island traces 5-40. As can also be seen from FIG. 5D, the middle (or ground) layer has spaced apart cutout regions or holes or windows 5-50. From FIG. 5D it can be seen that these holes/windows are not of uniform size or configuration as some are larger than others and that some are longer or taller than others, For clarity, the holes or cutout or window regions correspond to island traces on the top layer and to island traces on the bottom layer. The holes or cutout regions or windows allow for a signal from an island trace one layer to couple to an island trace on another layer.

From FIGS. 5A-5F, it can be seen that the matrix of couplers and the meander lines located in between the couplers form the Blass matrix. As well, it can be seen that the 12 bent lines with bent open-end stubs on the upper side of FIG. 5C form a phase-shifter group that would be adjacent the inputs to an antenna array. In one implementation, this example configuration was operated within the frequency band of 1.695 GHz-2.69 GHz. This phase shifter group, as implemented, would operate to reduce or cancel the beam squint. Of course, the various types of matrix circuits can be implemented with the implementation method detailed here. The phase shifter group illustrated in FIG. 5C can be removed and other methods to adjust/modify the characteristics and/or behavior of the matrix or the MBFN as a whole can be used. As an example, methods for adjusting/compensating for phase error can also be applied/implemented using the implementation method detailed here. In another example, the configuration in FIGS. 5A-5F uses a single row of phase shifters and these phase shifters are placed outside the Blass matrix to cancel beam squint. The matrix circuit can be implemented without the phase shifter group and the various aspects of the present invention can be implemented with the configuration devoid of the phase shifter group.

It should be clear that the multi-layer implementation method detailed in FIGS. 5A-5F is also applicable to other matrix circuit types. The implementation method detailed in this document can be applied to Blass matrix circuits, modified Blass matrix circuits, Nolen matrix circuits, and modified Nolen matrix circuits.

As another way to achieve better beam characteristics from the beams resulting from the matrix circuit, the holes or voids in the middle layer as well as the circuit traces on one or both of the top and bottom layers can be adjusted in terms of size, shape, and configuration. The holes can have non-parallel sides and the traces can also have a non-parallel based shape. Similarly, the shapes of the holes and traces can be non-conventional/non-regular. Such methods can be used to produce suitable matrix circuits using a multilayer configuration to produce beams with suitable characteristics.

The above MBFNs and the advances explained in this document can be applied to signals and applications that involve different frequency ranges including low band, mid-band, C-band, and high band frequencies. The various aspects of the present invention may also be used in conjunction with cellular applications that involve frequencies such as 600 MHz to 2.5 GHz, 450 MHz to 6 GHz, and 24 GHz to 52 GHz.

For even greater clarity, references to low band, mid-band, C-band, and high band frequencies in this document are to be taken to mean the following frequency ranges:
Low band: 617-960 MHz
Mid-band: 1695-2690 MHz
C-band: 3300-4200 MHz
High band: 24GHz-40 GHz

As is known to those of skill in the art, a directional coupler is a 4-port component that is used to couple a certain amount of power from its input port (port 1) to its output port (port 3), while the rest of the power passes through to the other output port (port 2). Ideally, no power should pass through the isolation port (port 4), and the reflected power from the input port should also be zero. It is therefore preferable to have a coupler with better return loss (RL) and better isolation (IS).

As explained above and as illustrated in FIGS. 5A-5F, some manufacturing methods for MBFNs use a multi-layer board, with two signal traces at the top and bottom layers and with a ground layer at the middle. The middle or ground layer has window gaps through which power is coupled from the top layer to the bottom layer. As can be seen from previous figures, in conventional designs and implementations, the shape of the metal/circuit traces (at the top and bottom layers) are generally rectangular and symmetrical. With such trace shapes, couplers operate and function well in the desired frequency range. For most coupler configurations, three parameters can be considered to adjust and/or improve coupler performance:
1—Coupler cutout Length: Determines the operating frequency range
2—Width (height) of the coupler (island) traces (top and bottom layers): Mostly contributes to matching the coupler to 50-ohm line, but also affect the coupling value as well.
3—Width (height) of the cutout window in the middle layer: Mostly contributes to the coupling value, but also affect the matching as well.

In a number of cases, it has been found that better efficiency, lower loss, and higher quality pattern results were achieved using couplers with a high coupling value (>3 dB). However, with the conventional designs, the coupler performance (in terms of return loss and isolation) tended to degrade as the coupling value increases past 3 dB.

In one aspect of the present invention, the metal traces at the top and bottom layers, as well as the cutout/window at the middle (or ground) layer have been adjusted to improve the coupler return loss and coupler isolation. These adjustments improved both coupler return loss and coupler isolation, leading to overall improvement of the system's performance. For clarity, these improvements include the use of rounded corners on the coupling window, rounded metal traces, symmetry and asymmetry on the metal traces, and adjusted height and length of the windows on the middle layer.

In the discussion below, results are presented for both conventional and novel couplers with coupling values of 2 dB and 3 dB in two different frequency bands in the mid-band and C-band frequency ranges. Also presented are S parameter results. For clarity, in the S parameter result figures, each S parameter contributes as follows:
1—S(1,1): Return Loss
2—S(2,1): Through
3—S(3,1): Coupling
4—S(4,1): Isolation

As will be seen in the results, using the same coupling values, the couplers that use the novel features improve the coupler return loss and coupler isolation. As noted above, couplers that use the novel features may be used with any beamforming networks, including MBFNs that use Blass, Nolen, modified Blass, modified Nolen, as well as others.

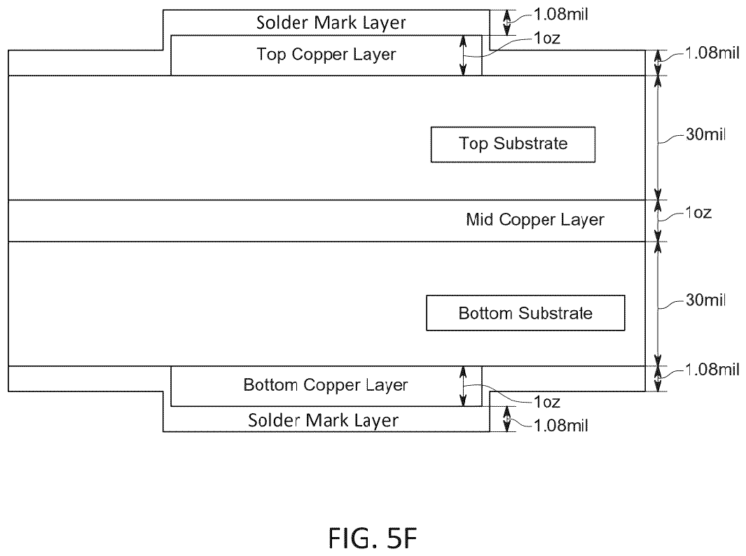

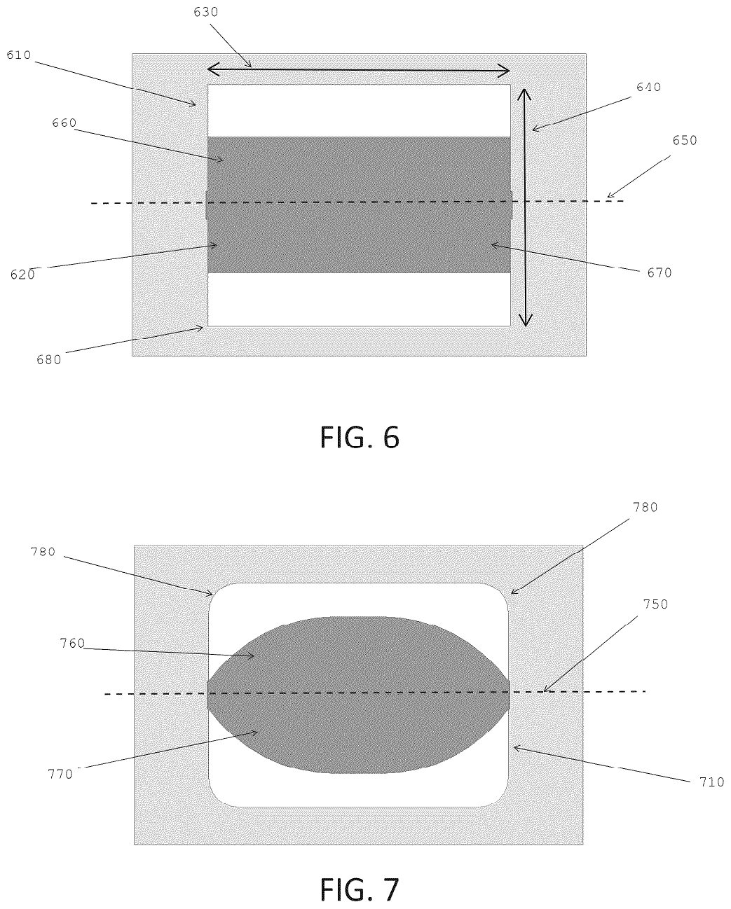

Referring to FIG. 6, illustrated is a conventional window 610 on the middle layer of the multilayer construction of an MBFN. As can be seen, the window 610 allows for a portion of an upper layer metal trace 620 to be exposed to a bottom layer metal trace (not shown). The window 610 has a length 630 and a height 640 as shown by the arrows. From the figure, it can be seen that the metal trace 620 is symmetrical about a center axis 650 (shown by a dotted line) that splits or bisects the metal trace (which is approximately rectangular in shape) into an upper half 660 and a bottom half 670. Also, as can be seen from FIG. 6, the corners 680 of the window are squared or are sharp.

Referring to FIG. 7, illustrated is a window 710 on the middle layer of a multilayer construction of an MBFN according to one aspect of the present invention. As can be seen, the window 710 on a middle or ground layer of a multilayer construction of an MBFN has rounded corners 780 on each of the four corners. The metal trace seen through the window 710 has an upper half 760 and a lower half 770. As can be seen, the upper half 760 mirrors the lowers half 770 and, as such, the metal trace 760 is symmetrical about the center axis 750. Notably, instead of straight edges on the metal trace as in FIG. 6, the metal trace in FIG. 7 has curved or bulging edges. In short, the metal trace in FIG. 7, when the upper and lower halves are combined, generally forms a prolate spheroid in shape.

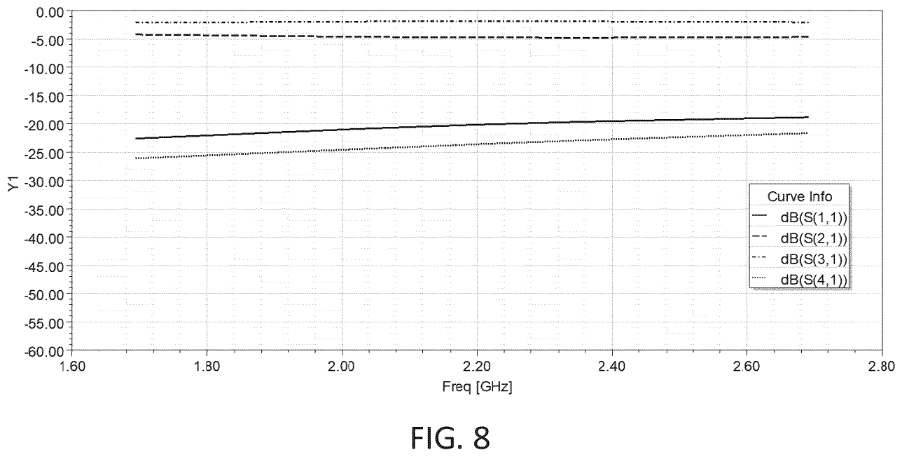

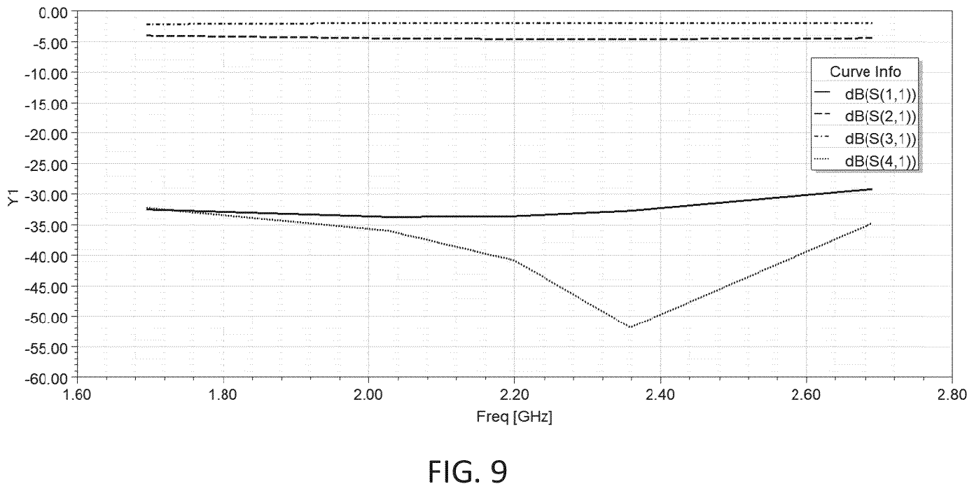

In terms of performance, the S parameter results for the conventional window in FIG. 6 are shown in FIG. 8. The S parameter results for the configuration shown in FIG. 7 are provided in FIG. 9. When contrasting the two sets of S parameter results, it can be seen that the return loss and isolation for the configuration in FIG. 7 has significantly improved over the performance for the configuration in FIG. 6. For clarity, the configurations in FIG. 6 and FIG. 7 were 2 dB couplers tested in mid-band frequencies (1.695 GHz to 2.69 GHz).

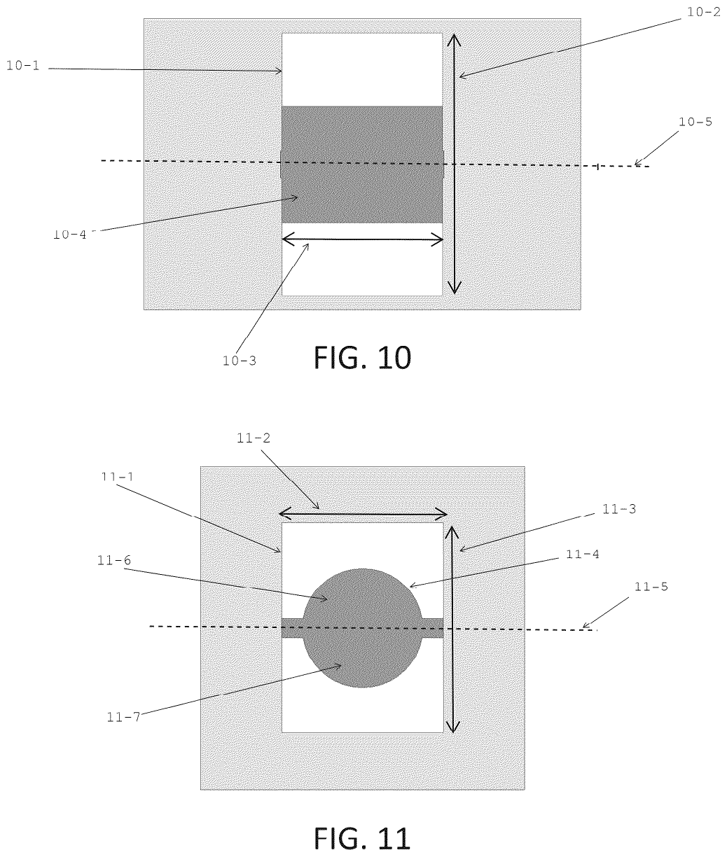

Referring to FIG. 10, another conventional configuration is illustrated. As can be seen, the window 10-1 in FIG. 10 has a height 10-2 and a length 10-3 and a metal trace 10-4 can be seen through the window 10-1. The metal trace 10-4 is symmetrical about the center axis 10-5. As can be seen, the length 10-3 of the window is smaller in value than the value of the height of the window. For clarity, the window in FIG. 10 is shorter in length than its height. The metal trace 10-4 is shown as being generally almost square in shape.

Referring to FIG. 11, another configuration according to another aspect of the present invention is illustrated. As can be seen, the window 11-1 in FIG. 11 has a length 11-2 and a height 11-3 and that its height is higher in value than its length. The metal trace 11-4 is visible through the window and trace 11-4 is bisected by an axis 11-5. The metal trace has an upper half 11-6 and a lower half 11-7. The metal trace 11-4 is symmetrical about the axis 11-5 such that the upper half 11-6 is a mirror image of the lower half 11-7 about the axis 11-5. As can be seen, the upper half is an upper half circle while the lower half is a lower half circle. The corners of the window 11-1 are squared or sharp and are not rounded.

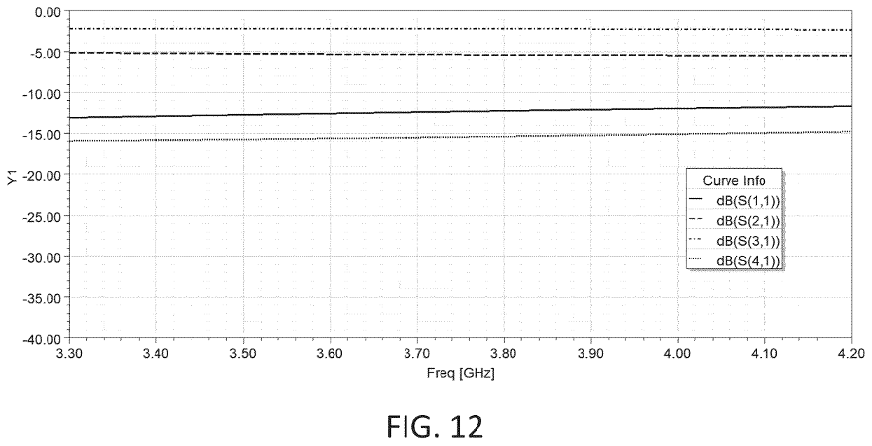

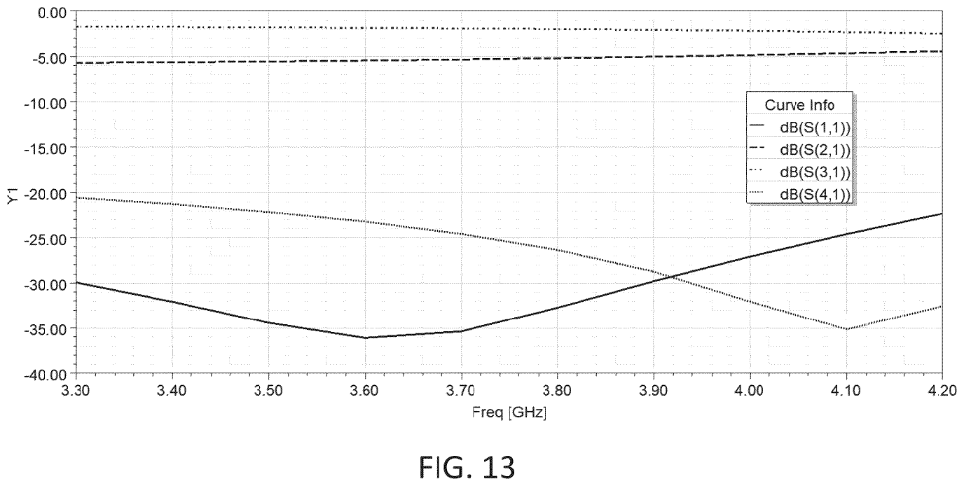

The configuration in FIG. 10 was compared to the configuration in FIG. 11. The 2 dB couplers were tested using C-band frequencies and the S parameter results are provided in FIG. 12 and FIG. 13. FIG. 12 shows the S parameter results for the conventional configuration in FIG. 10 while FIG. 13 shows the S parameter results for the configuration illustrated in FIG. 11. As can be seen, the use of the innovations shown in FIG. 12 improved the performance of the coupler.

It should be clear that, while the use of curves in the metal traces (e.g. use of the circular/prolate spheroid shaped metal traces vs. rectangular/square shaped metal traces) improves the performance of the coupler, the use of rounded corners in the middle layer windows also contributes to the improved performance. It should also be clear that, while the metal traces shown in FIG. 6, FIG. 7, FIG. 10, and FIG. 11 are symmetrical about a center axis, other configurations that are asymmetrical about the center axis will also work. Thus, the upper half of a metal trace may use curves while the lower half may simply use a rectangle or a square. Similarly, the upper half of a metal trace may used a rectangle or a square while the lower half may use curves such as a half circle or half of a curved shape. Similarly, the dimensions of the window itself may be asymmetrical such that the window is longer than it is tall (i.e., the window has a higher length value than its height value) or the window may be taller than it is long (i.e., the window has a smaller or lower length value than its height value).

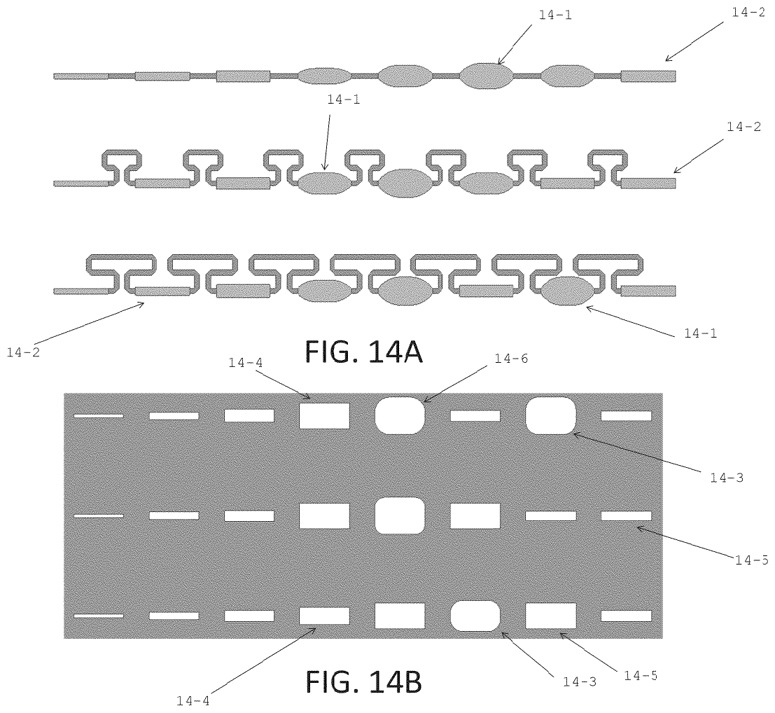

Referring to FIG. 14A and FIG. 14B, illustrated are variants of the island traces that may be used as well as variants of the cutouts or holes that may be used. As should be understood, the island trace configurations can be used for circuit traces on the top and/or bottom layers of the multilayer configuration while the hole/cutout configurations can be used with the middle or ground layer of the multilayer configuration of which FIGS. 5A-5F are examples. From FIG. 14A, the island trace or circuit trace may a prolate spheroid as a shape (see island trace 14-1 in FIG. 14A) or a more regular elongated rectangle as a shape (see island trace 14-2 in FIG. 14A).

Regarding the shape of the hole/cutout used in the middle layer, the hole/cutout can have rounded corners (see holes/cutouts 14-3 in FIG. 14B) or it can have squared or sharp corners (see holes/cutouts 14-4 in FIG. 14B). In terms of hole/cutout length, the hole/cutout can be elongated (see hole/cutout 14-5 in FIG. 14B) or the hole/cutout can be less elongated and have almost equal height/length values (see, for example, hole/cutout 14-6 in FIG. 14B). Of course, the hole/cutout may be taller than it is long (see, for example, the configuration in FIG. 10 and FIG. 11). The hole/cutout may be longer than it is long (see, for example, the configuration shown in FIG. 6 and FIG. 7). As can be seen from FIG. 14B, different types of configurations of holes/cutouts can be used on a single instance of a middle layer. Similarly, as can be seen from FIG. 14A, different configurations of island trace or circuit trace may be used in a single line of island traces.

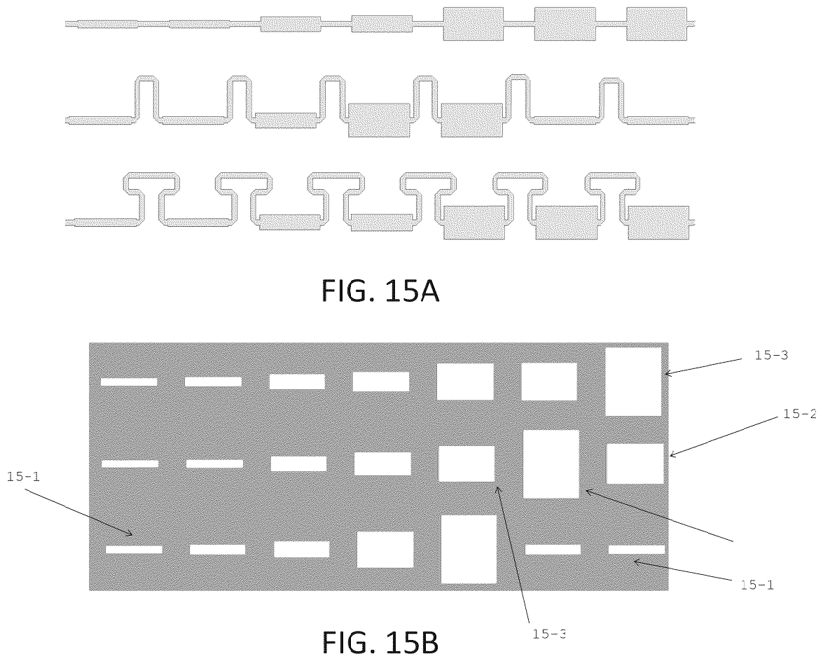

Referring to FIG. 15A and FIG. 15B, further examples of island trace configurations and holes/cutouts are provided. In FIG. 15A, the island traces shown use squared/sharp corners and are rectangular in shape, illustrating configurations that are symmetrical about a center axis and that are elongated. In FIG. 15B, the hole/cutout configurations are elongated (see hole/cutout 15-1), are almost square in shape (see hole/cutout 15-2), or are taller than long (see hole/cutout 15-3). All the configurations shown in FIG. 15B uses sharp or squared corners.

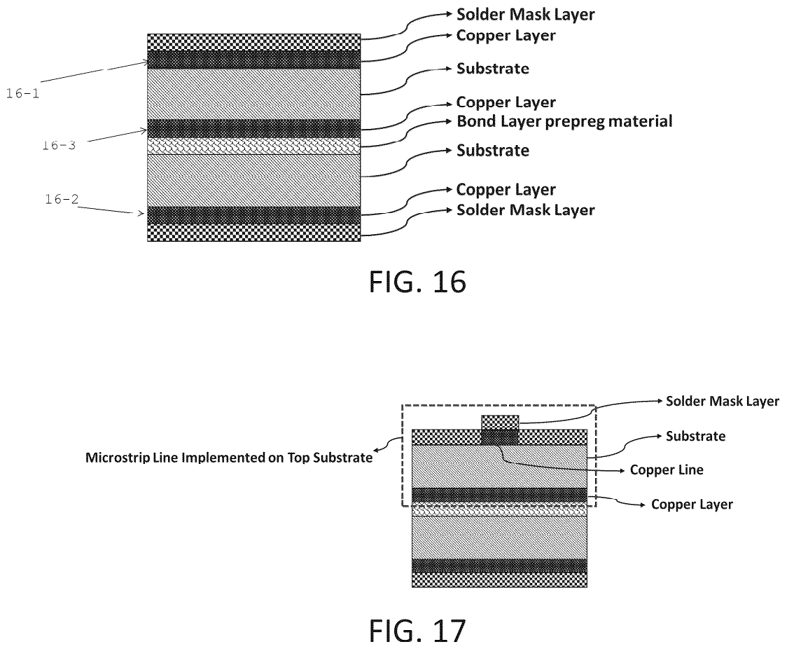

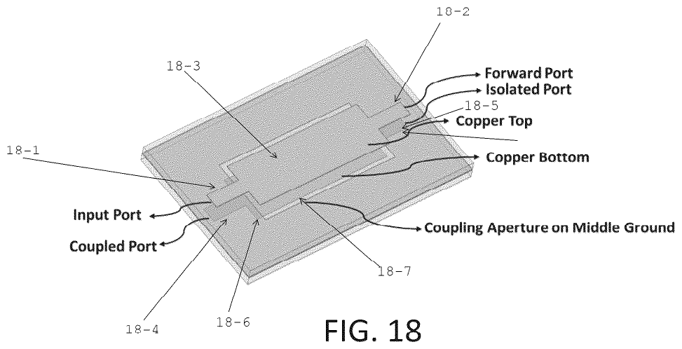

Referring to FIG. 16, a side cutout of an implementation of one aspect of the present invention as detailed in FIGS. 5A-5F is illustrated. As can be seen, FIG. 16 details the layers in the implementation. The copper layer 16-1 is used for the top layer while copper layer 16-2 is used for the bottom layer. Copper layer 16-3 operates as the middle or ground layer with a suitably shaped hole/cutout. FIG. 17 shows a microstrip implementation using the stacked layers shown in FIG. 16. FIG. 18 shows a perspective view of one section of the stacked or multilayer implementation of one aspect of the present invention. As can be seen, the various input and output ports of a directional coupler as implemented using one aspect of the present invention are detailed in the Figure. The input port 18-1 and the forward port 18-2 are on the top layer (i.e., the “copper top” 18-3) while the coupled port 18-4 and the isolated (or isolation port) 18-5 are on the bottom layer (i.e., the “copper bottom” 18-6). The hole/cutout 18-7 is on the middle or ground layer.

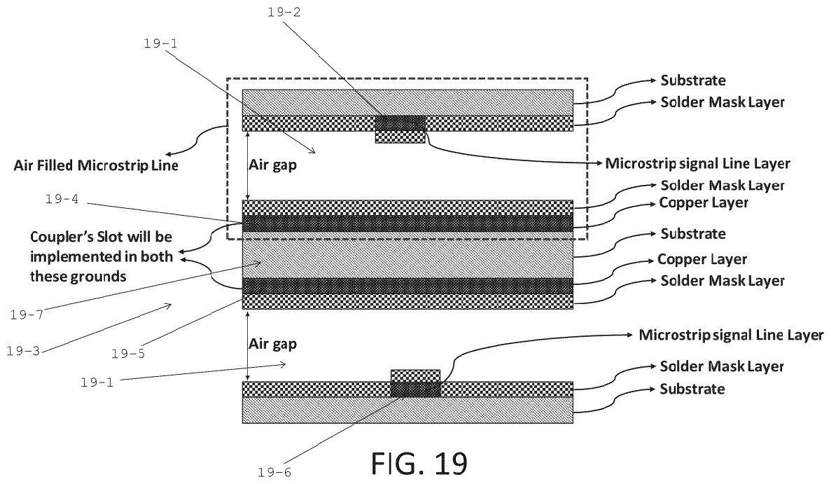

Referring to FIG. 19, illustrated is another implementation of one aspect of the present invention. For this implementation, an air gap is used between the top layer and the middle (ground) layer and between the middle (ground) layer instead of a solid substrate. As should be known to those of skill in the art, air-filled microstrip technology is a variation of the conventional microstrip line used in microwave and RF circuits. Air-filled microstrip technology offers several advantages over traditional microstrip lines, primarily due to the use of air as the dielectric material instead of a solid dielectric substrate. Since air has a lower dielectric constant and loss tangent compared to typical substrate materials, this results in lower dielectric losses and higher efficiency at high frequencies. The use of air as a dielectric in the design and manufacture of MBFNs can reduce insertion loss.

As can be seen from FIG. 19, there is an air gap 19-1 between the top layer 19-2 and the middle layer 19-3. Of course, the middle layer 19-3, in this implementation, consists of multiple layers including two copper layers 19-4, 19-5 that operate as the ground layer for the top layer 19-2 and the bottom layer 19-6. Both of these copper layers 19-4, 19-5 would each have a suitably dimensioned and shaped hole/cutout as detailed above. The hole/cutout allows for coupling between the top layer 19-2 and the bottom layer 19-6. As can be seen, there is a substrate layer 19-7 between the two copper layers 19-4, 19-5. Together, the copper layers 19-4, 19-5, the substrate layer 19-7 (and the solder mask layers) form the middle layer in this multilayer implementation of one aspect of the present invention. Both the top layer 19-2 and the bottom layer 19-6 are each implemented using a microstrip on top of a substrate with a gap in the solder mask layers to result in a microstrip signal line layer atop the gap. A section of solder mask layer is placed on top of the microstrip such that the section of solder mask layer protrudes into the air gap between the top/bottom layer and the multilayer middle layer.

In another aspect of the present invention, there is provided a coupler configuration that is useful for coupling power between signal ports. As with the aspects of the present invention as explained above, this coupler may be used in the configuration and implementation of MBFNs including Blass, Nolen, modified Blass, modified Nolen, and Butler matrices.

It should be clear that the typical microstrip (MS) structure incurs a loss and that this may lead to higher losses in Blass, Nolen, or modified Blass, or modified Nolen networks. Such a loss can subsequently cause a drop in antenna array gain. This can be mitigated by applying Suspended Strip-line (SSL) technology to a coupler. Such a coupler can then be used in MBENs.

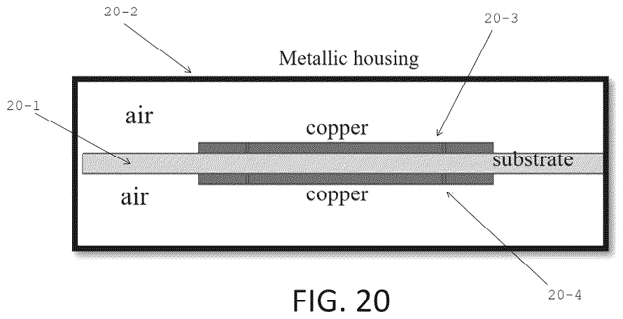

Referring to FIG. 20, illustrated is a schematic view of such a structure. As can be seen, the structure consists of a thin double-sided metallized dielectric substrate 20-1 with a metallic housing 20-2. Copper traces are on a top layer 20-3 and on a bottom layer 20-4, with the top and bottom layers sandwiching the substrate 20-1 between them. The housing 20-2 encloses the substrate and the copper traces and there is air within the housing such that air is between the housing and the top and bottom layers.

By using such a structure for a coupler, not only will the gain drop be addressed, but the structure also reduces the impact of other antenna elements and even the effect of other MBFN boards within the overall antenna structure. Such a structure can improve or enhance the overall functionality of the antenna.

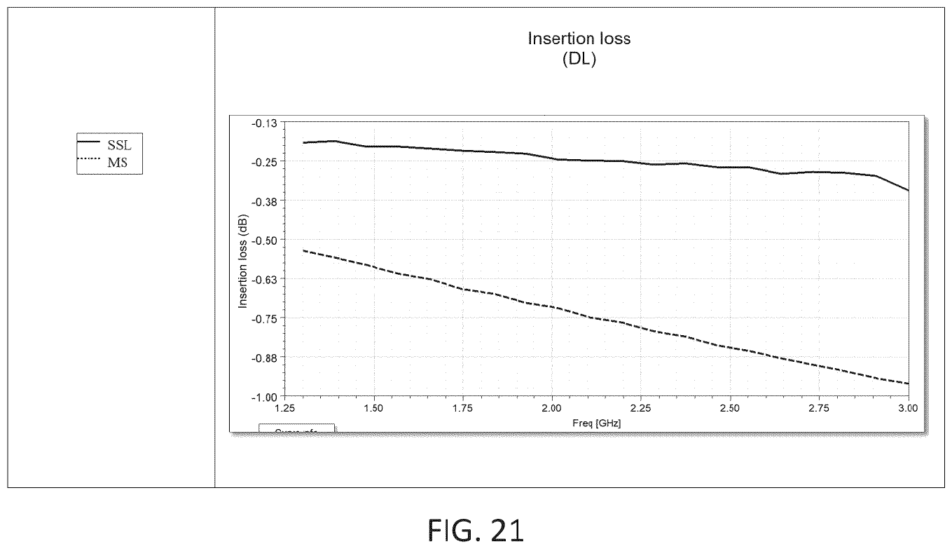

Referring to FIG. 21, illustrated is a plot of insertion loss for both the SSL technology and microstrip technology using the same electrical lengths. As can be seen, SSL technology exhibits significantly lower loss as compared to microstrip technology. This reduction in loss helps to compensate for gain drop in MBFNs, especially when used in larger arrays with higher beam ports. As well, SSL technology is particularly effective in the lower beams, where loss tends to accumulate.

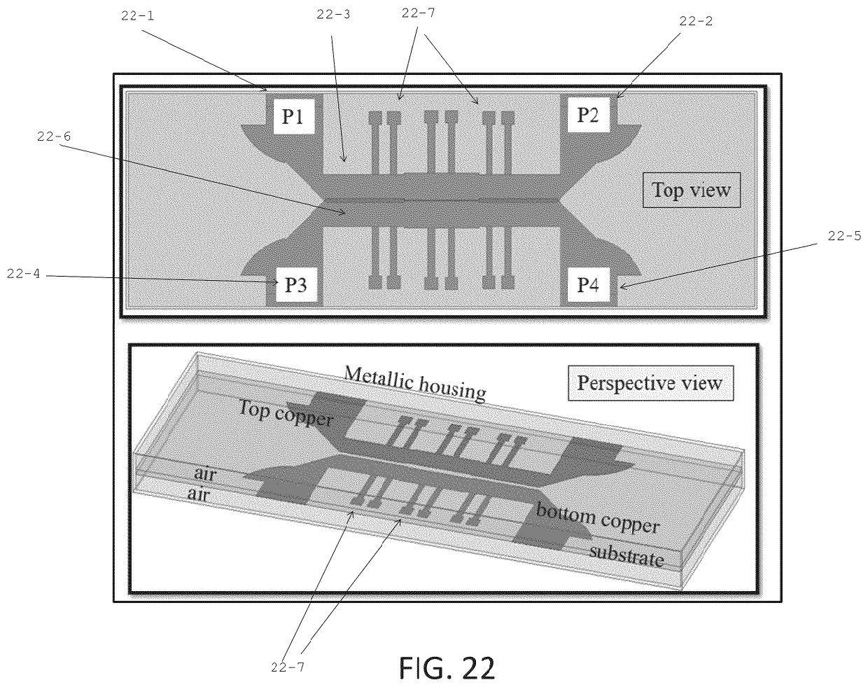

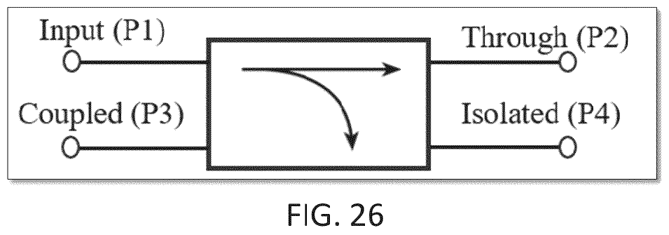

Referring to FIG. 22, illustrated is one configuration of this aspect of the present invention. As can be seen, the top image in FIG. 22 shows a top view of a coupler according to one aspect of the present invention while the bottom image in FIG. 22 shows a perspective view of the coupler. As can be seen, the structure in FIG. 20 is used, with the top copper trace including the PI port 22-1 and the P2 port 22-2 and the connecting trace 22-3 between the two ports. The bottom copper trace includes the P3 port 22-4, the P4 port 22-5 and the connecting trace 22-6 between the two ports. For clarity, the top trace is atop the substrate while the bottom trace is at the bottom of the substrate. Fingers 22-7 are present and extend from both the top connecting trace 22-3 and the bottom connecting trace 22-6. The coupler structure illustrated in FIG. 22 is housed inside a metallic housing. It should also be clear that the various ports and their functions are as denoted in FIG. 26. As can be seen, port P1 is the input port while port P2 is the through port. Port P3 is the coupled port while port P4 is the isolated or isolation port.

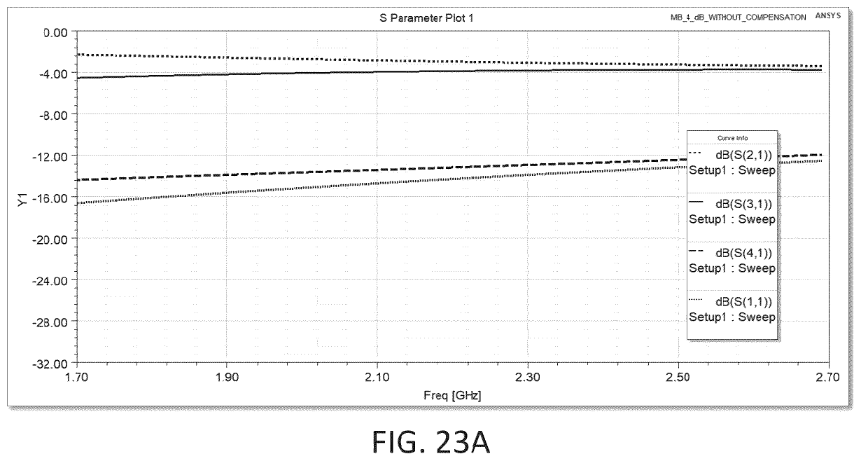

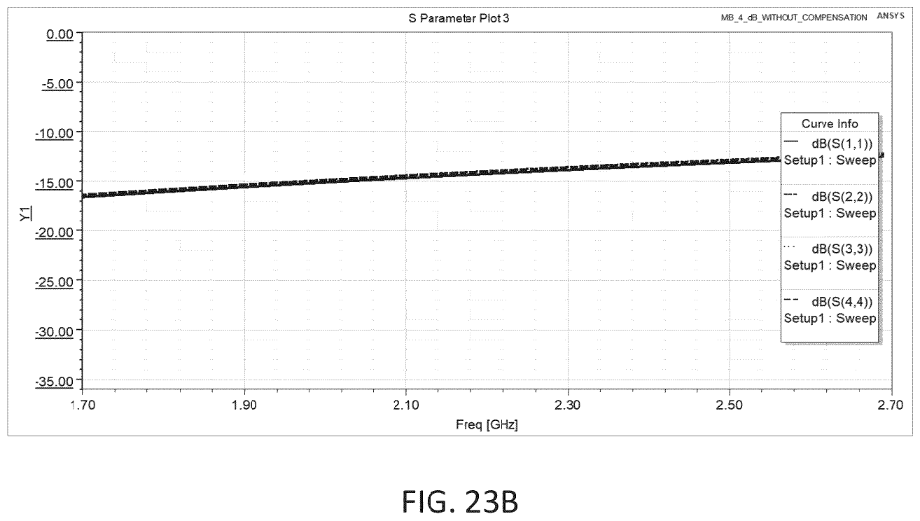

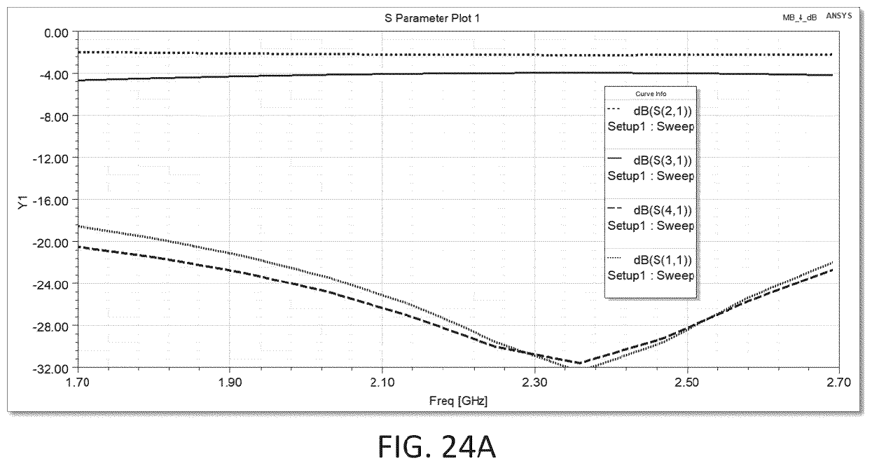

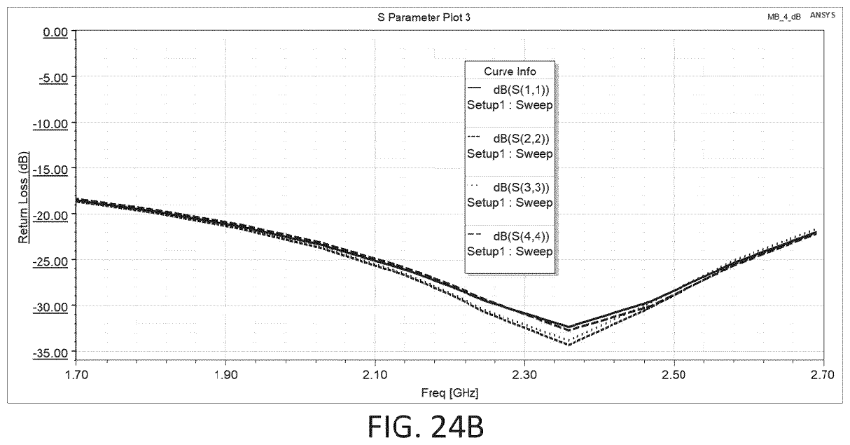

It should be clear that, while low isolation and high return loss associated with SSL coupler technology may make an SSL coupler difficult to use in multibeam networks, this aspect of the present invention mitigates/addresses this potential issue. Sample instances of the SSL coupler according to this aspect of the present invention were tested alongside a conventional SSL coupler. The S parameter results for the conventional SSL coupler are shown in FIG. 23A and FIG. 23B while the S parameter results for the SSL coupler according to one aspect of the present invention are shown in FIG. 24A and FIG. 24B. These results were obtained with a coupling factor of 4 dB.

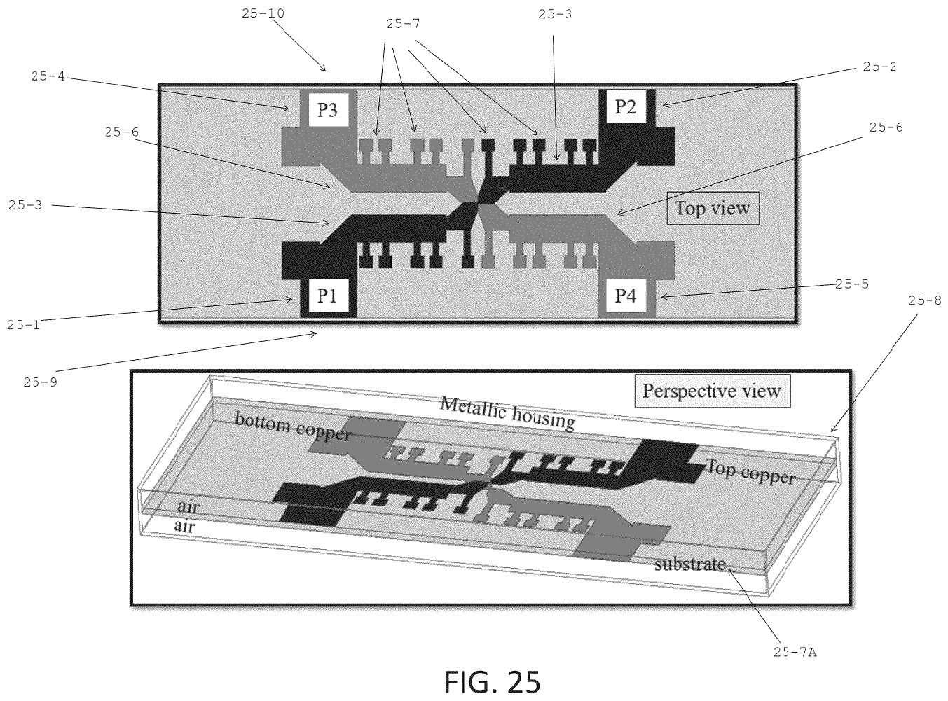

Referring to FIG. 25, illustrated is another configuration of the SSL coupler according to another aspect of the present invention. As can be seen, this configuration also uses the structure illustrated in FIG. 20. The top image in FIG. 25 shows a top view of the SSL coupler while the bottom image in FIG. 25 shows a perspective view of the SSL coupler. The coupler includes a port P1 25-1 that is coupled to a port P2 25-2 by way of a delay or connecting trace 25-3. A port P3 25-4 is coupled to a port P4 25-5 by way of a delay or connecting trace 25-6. Both connecting traces 25-3, 25-6 have fingers 25-7 that extend away from the traces and are on the same side of the nearest port on the same side of the substrate.

For clarity, the top trace consists of the port P1 25-1, port P2 25-2, and the delay or connecting trace 25-3. The bottom trace consists of the port P3 25-4, port P4 25-5, and delay or connecting trace 25-6. Between the top and bottom traces is a substrate layer 25-7A. As with the configuration in FIG. 22, the constructed SSL coupler in FIG. 25 is encased in a metallic housing 25-8. Also, as can be seen, the coupler has a first side 25-9 and a second side 25-10, with the first and second sides both being elongated sides and being opposite one another. The port PI and port P2 are on different sides, with port P1 being adjacent the first side and port P2 being adjacent the second side. The port P3 is adjacent the second side while the port P4 is adjacent the first side. The fingers extending from the delay or connecting traces 25-3, 25-6 extend away from the traces and are extending towards the nearest elongated side and towards the side that the nearest port (on the same side) is adjacent to. Thus, the fingers adjacent port Pl are extending away from the connecting trace 25-3 and towards the first elongated side 25-9. Similarly, the fingers adjacent port P3 are extending away from connecting trace 25-6 and towards the second side 25-10.

Interestingly, the SSL coupler illustrated in FIG. 25 has been configured such that the delay lines on opposite sides of the substrate (and which connect the coupler ports (coupling port P1 to port P2 and coupling port P3 to port P4)) do not overlap. This avoids undesired coupling and pattern issues. More conventional SSL port configurations can pose problems when used in multibeam boards.

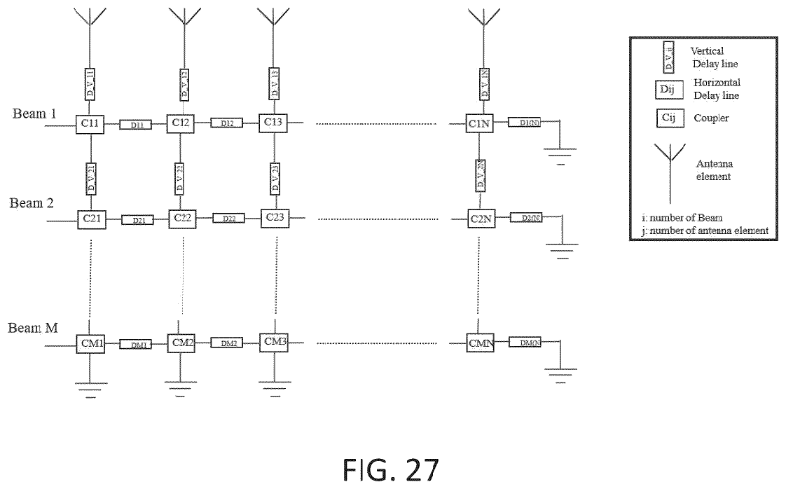

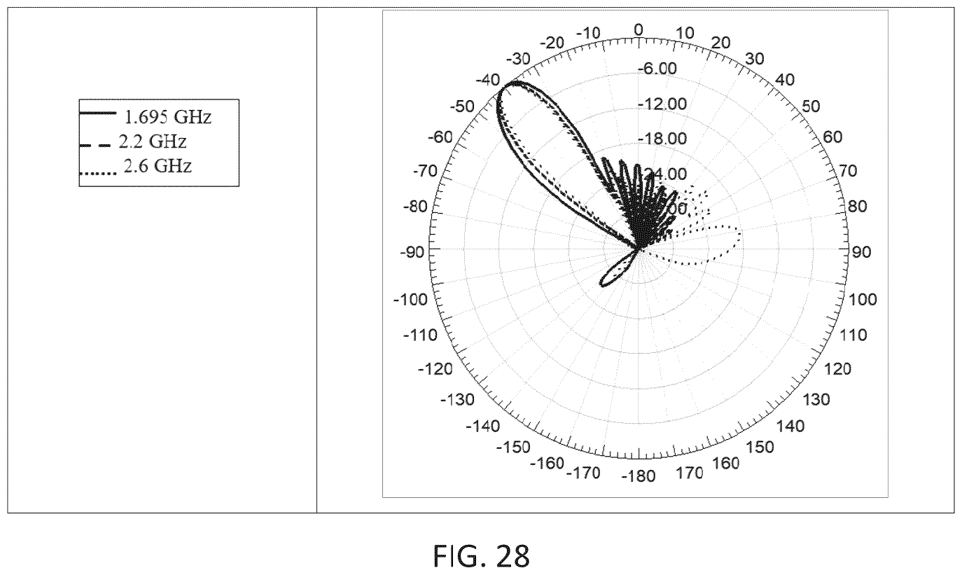

The configured SSL coupler illustrated in FIG. 25 was tested in an MBFN configured as a Blass matrix (see FIG. 27). Test results were compared to those of a standard Blass matrix MBFN and both configurations were configured for a single beam. The antenna radiation pattern for the MBFN using the SSL coupler as configured in FIG. 25 is shown in FIG. 28. As can be seen from FIG. 28, the antenna pattern has a well-defined shape with a low side lobe level (SLL). Interestingly, the resulting antenna pattern does not exhibit beam squint. For clarity, while the sample implementation was tested in a Blass matrix MBFN, the SSL coupler can be applied to any MBFN including a Nolen, modified Blass, modified Nolen, and Butler configured MBEN with any number of inputs and outputs. This aspect of the present invention can also be used in any frequency band, including wideband frequencies and mid-band frequencies. As well this aspect of the present invention may also be used in conjunction with cellular applications that involve any frequency bands in FR1 (410-7125 MHz), FR3 (7.125 to 24.25) GHz or FR2 (24.25-71.0 GHz).

A person understanding this invention may now conceive of alternative structures and embodiments or variations of the above all of which are intended to fall within the scope of the invention as defined in the claims that follow.

We claim:

1. A multi beam forming network of circuit elements manufactured using a multi-layer structure, said multi-layer construction comprising
a top layer having a top circuit trace, said top circuit trace being a continuous top trace having at least one top island trace;
a middle ground layer having at least one window;
a bottom layer having a bottom circuit trace, said bottom circuit trace being a continuous bottom trace having at least one bottom island trace;
wherein
at least one of said at least one window aligns with both of said at least one top island trace and said at least one bottom island trace such that coupling occurs between signals passing through said at least one top island trace and said at least one bottom island trace;
said at least one window is configured with a plurality of corners and said at least one window having a length and a height.

2. The network according to claim 1, wherein said at least one window has rounded corners.

3. The network according to claim 1, wherein at least one of said at least one top island trace is symmetrical about a center longitudinal axis of said continuous trace.

4. The network according to claim 1, wherein at least one of said at least one bottom island trace is symmetrical about a center longitudinal axis of said continuous bottom trace.

5. The network according to claim 1, wherein at least one of said at least one top island trace is asymmetrical about a center longitudinal axis of said continuous trace.

6. The network according to claim 1, wherein at least one of said at least one bottom island trace is asymmetrical about a center longitudinal axis of said continuous bottom trace.

7. The network according to claim 1, wherein said middle ground layer has a plurality of windows.

8. The network according to claim 7, wherein at least one of said plurality of windows is differently configured from others of said plurality of windows.

9. The network according to claim 8, wherein at least one of said plurality of windows is differently shaped from others of said plurality of windows.

10. The network according to claim 8, wherein at least one of said plurality of windows is differently sized from others of said plurality of windows.

11. The network according to claim 7, wherein at least one window of said plurality of windows has a height that is greater in value than its length.

12. The network according to claim 7, wherein at least one window of said plurality of windows has a length that is greater in value than its height.

13. The network according to claim 1, wherein there is an air gap between said top layer and said middle layer.

14. The network according to claim 1, wherein there is an air gap between said bottom layer and said middle layer.

15. The network according to claim 1, wherein said middle layer comprises multiple layers.

16. The network according to claim 15, wherein said middle layer comprises at least two copper layers that operate as ground layers for said top layer and said bottom layer.

17. A signal coupler that comprises a substrate having a first side and a second side that is opposite said first side, the coupler comprising:
a first layer atop said substrate, the first layer comprising a first conductive trace with a first port at one end of said first conductive trace and a second port at another end of said first conductive trace, said first port being located adjacent said first side and said second port being located adjacent said second side;
a second layer underneath said substrate, the second layer comprising a second conductive trace with a third port at one end of said second conductive trace and a fourth port at another end of said second conductive trace, said third port being located adjacent said second side and said fourth port being located adjacent said first side;
a metallic housing enclosing said coupler;
wherein said first layer and said second layer are both separated from said metallic housing by an air gap.

18. The coupler according to claim 17, wherein said substrate is a metallized dielectric,

19. The coupler according to claim 17, further comprising conductive fingers that extend from said conductive traces towards a nearest side of said first and second sides.

20. The coupler according to claim 17, wherein an area of said substrate covered by said first conductive trace atop said substrate does not overlap an area of said substrate covered by said second conductive trace underneath said substrate.
